(19) United States
(12) Patent Application Publication
(10) Pub. No.: US 2025/0202356 A1
(43) Pub. Date: Jun. 19, 2025

(54) VOLTAGE CONVERSION CIRCUIT

(71) Applicant: Montage Technology (Kunshan) Co., Ltd., Suzhou (CN)

(72) Inventors: Zongjie Hu, Shanghai (CN); Xuexin Ding, Shanghai (CN)

(73) Assignee: Montage Technology (Kunshan) Co., Ltd., Suzhou (CN)

(21) Appl. No.: 18/953,070

(22) Filed: Nov. 20, 2024

(30) Foreign Application Priority Data
Dec. 15, 2023 (CN) 202311733218.3

(51) Int. Cl. H02M 3/156; H02M 1/00

(52) U.S. Cl. CPC H02M 3/156; H02M 1/0009; H02M 1/0043

(57) ABSTRACT

Disclosed is a voltage conversion circuit. The voltage conversion circuit includes multiple voltage converters, a feedback circuit, and an interleaving controller. The voltage converters are connected in parallel and jointly generate an output voltage according to multiple control signals respectively. The feedback circuit is coupled to the voltage converter. The feedback circuit generates multiple feedback signals according to a switching voltage on a power switch of each voltage converter and an error voltage between the output voltage and a first reference voltage. The interleaving controller is coupled between the feedback circuit and the voltage converter. The interleaving controller includes a plurality of phase-locked loops respectively corresponding to the voltage converters. The interleaving controller generates multiple control signals according to the feedback signal and the zero-crossing detection state of the power switch of the voltage converter through a phase-locking mechanism.

### CROSS-REFERENCE TO RELATED APPLICATION

This application claims the priority benefit of China application serial no. 202311733218.3, filed on Dec. 15, 2023. The entirety of the above-mentioned patent application is hereby incorporated by reference herein and made a part of this specification.

### BACKGROUND

### Technical Field

The disclosure relates to a voltage conversion circuit, and particularly relates to a voltage conversion circuit of a quasi-interleave mechanism capable of operating in a multi-phase discontinuous conduction mode (DCM).

### Description of Related Art

In the related art, a voltage conversion circuit may be implemented via a pulse distribution architecture or a phase-locked loop architecture. The voltage conversion circuit implemented by the pulse distribution architecture has high noise sensitivity and relatively slow response rate. The voltage conversion circuit implemented by the phase-locked loop architecture of the related art has relatively low noise sensitivity and relatively fast response rate, but has a relatively complex circuit architecture. Furthermore, the voltage conversion circuit implemented with a phase-locked loop architecture can only implement the interleaving function in a continuous conduction mode (CCM), which cannot meet application requirements.

### SUMMARY

The disclosure is directed to a voltage conversion circuit which can operate in a quasi-interleave state based on a phase-locking mechanism.

According to an embodiment of the disclosure, a voltage conversion circuit includes a plurality of voltage converters, a feedback circuit, and an interleaving controller. The voltage converters are connected in parallel and jointly generate an output voltage according to multiple control signals respectively. The feedback circuit is coupled to the voltage converter. The feedback circuit generates multiple feedback signals according to the switching voltage on a power switch of each voltage converter and the error voltage between the output voltage and the first reference voltage. The interleaving controller is coupled between the feedback circuit and the voltage converter. The interleaving controller includes a plurality of phase-locked loops respectively corresponding to the plurality of voltage converters. The interleaving controller turns on or off a phase-locking mechanism according to a zero-crossing detection state of the power switch, and generates a plurality of control signals according to a plurality of feedback signals and the zero-crossing detection state.

### BRIEF DESCRIPTION OF THE DRAWINGS

FIG. 1 is a schematic diagram of a voltage conversion circuit according to an embodiment of the disclosure.

FIG. 2 is a schematic diagram of an implementation of a feedback circuit in a voltage conversion circuit according to an embodiment of the disclosure.

FIG. 3 is a schematic diagram of an implementation of an interleaving controller in a voltage conversion circuit according to an embodiment of the disclosure.

FIG. 4 is a schematic diagram showing an implementation of the core circuit in FIG. 3.

FIG. 5 is an operation waveform diagram of the core circuit of the embodiment of FIG. 4 of the disclosure.

FIG. 6A and FIG. 6B are waveform diagrams of switching voltage, inductance current, and output voltage of the voltage conversion circuit of the disclosure under different loads.

### DESCRIPTION OF THE EMBODIMENTS

Reference will now be made in detail to exemplary embodiments of the disclosure, examples of the embodiments are illustrated in the accompanying drawings. Whenever possible, the same reference numerals are used in the drawings and the description to refer to the same or similar parts.

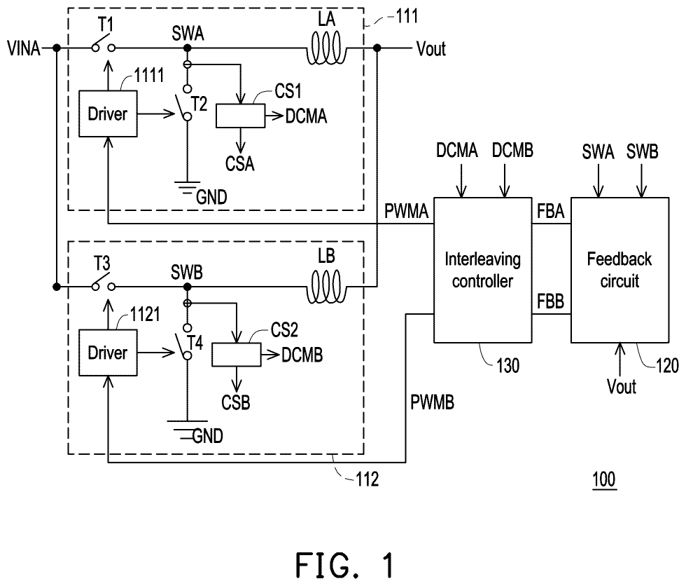

Please refer to FIG. 1. FIG. 1 is a schematic diagram of a voltage conversion circuit according to an embodiment of the disclosure. A voltage conversion circuit 100 includes a plurality of voltage converters 111, 112, a feedback circuit 120, and an interleaving controller 130. The voltage converters 111, 112 are coupled in parallel between the input terminal and the output terminal of the voltage conversion circuit, in which the output terminal of the voltage converter 111 and the output terminal of the voltage converter 112 are coupled to each other, the voltage converters 111, 112 both receive an input voltage VINA and perform voltage conversion operations on the input voltage VINA according to the control signals PWMA, PWMB respectively, and jointly generate an output voltage Vout at the output terminals coupled to each other.

In this embodiment, the voltage converter 111 includes power switches T1, T2. The first terminals of the power switches T1, T2 are both coupled to an inductor LA. The second terminal of the power switch T1 receives the input voltage VINA, and the second terminal of the power switch T2 is grounded. The control terminals of the power switches T1, T2 are both coupled to a driver 1111, and are switched on/off by receiving a driving signal provided by the driver 1111, so as to generate a switching voltage SWA at a terminal coupled to the inductor LA. The power switches T1, T2 are alternately turned on and off under the control of the driving signal to perform voltage conversion on the input voltage VINA and generate a first partial voltage of the output voltage Vout at the output terminal of the voltage converter 111 by the inductor LA as an energy storage element. Here, the driver 1111 receives the control signal PWMA from the interleaving controller 130, and provides a driving signal to the power switches T1, T2 according to the control signal PWMA.

Similarly, the voltage converter 112 includes power switches T3, T4. The first terminals of the power switches T3, T4 are both coupled to an inductor LB, the second terminal of the power switch T3 receives the input voltage VINA, and the second terminal of the power switch T4 is grounded. The control terminals of the power switches T3, T4 are both coupled to a driver 1121, and are switched on/off by receiving the driving signal provided by the driver 1121, so as to generate a switching voltage SWB at a terminal coupled to the inductor LB. Through the similar operation as the voltage converter 111, the voltage converter 112 can generate a second partial voltage of the output voltage Vout at the output terminal. Here, the driver 1121 receives the control signal PWMB from the interleaving controller 130, and provides a driving signal to the power switches T3, T4 according to the control signal PWMB.

It is worth mentioning that the control signals PWMA, PWMB are both pulse width modulation (PWM) signals, and there may be a certain phase difference between the two signals. By using the control signals PWMA, PWMB with a phase difference, the voltage converters 111, 112 can operate in a quasi-interleave mechanism.

In this embodiment, the voltage converters 111, 112 may be buck converters.

In this embodiment, the voltage conversion circuit 100 further includes current sensors CS1, CS2. The current sensor CS1 may be coupled to the first terminal of the power switch T2 and configured to sense the current on the power switch T2 and generate current information CSA. Furthermore, the current sensor CS1 can obtain the zero-crossing detection state of the first terminal of the power switch T2 according to the current information CSA, and further obtain pattern information DCMA about the DCM mode of the voltage converter 111. Similarly, the current sensor CS2 can be coupled to the first terminal of the power switch T4 and used to sense the current of the power switch T4 to generate current information CSB. Furthermore, the current sensor CS2 can obtain the zero-crossing detection state of the first terminal of the power switch T4 according to the current information CSB, and obtain pattern information DCMB about the DCM mode of the voltage converter 112. The pattern information DCMA, DCMB may be digital signals, and the logic values thereof may be used to indicate whether the power switch T2, T4 are in a zero-crossing detection state.

The feedback circuit 120 is coupled to the voltage converters 111, 112 and the interleaving controller 130. The feedback circuit 120 may receive the output voltage Vout and the switching voltages SWA, SWB. The feedback circuit 120 detects the error between the output voltage Vout and a reference voltage and generates an error voltage. The feedback circuit 120 generates a feedback signal FBA according to the error voltage and the switching voltage SWA, and generates a feedback signal FBB according to the error voltage and the switching voltage SWB.

The interleaving controller 130 is coupled to the feedback circuit 120 and the voltage converters 111, 112. The interleaving controller 120 includes two phase-locked loops (not shown in FIG. 1) respectively corresponding to the voltage converters 111, 112. The interleave controller 130 may determine whether to enable the phase-locking mechanism of the phase-locked loop according to the pattern information DCMA, DCMB. In the discontinuous conduction mode, the phase-locking mechanism of the phase-locked loop is disabled, at this time, the interleaving controller 130 may generate the control signals PWMA, PWMB according to the feedback signals FBA, FBB and the pattern information DCMA, DCMB, and control the voltage conversion of the voltage converters 111, 112 through the control signals PWMA, PWMB. In this embodiment, the interleaving controller 130 can ensure that the voltage converters 111, 112 can stably operate in the discontinuous conduction state by expanding the width of the positive pulse wave of the control signals PWMA, PWMB based on a hysteresis mechanism.

On the other hand, in the continuous conduction mode (CCM), the interleaving controller 120 may enable a phase-locked loop therein. As a result, the interleaving controller 130 can generate the control signals PWMA, PWMB based on the phase-locking mechanism of the phase-locked loop.

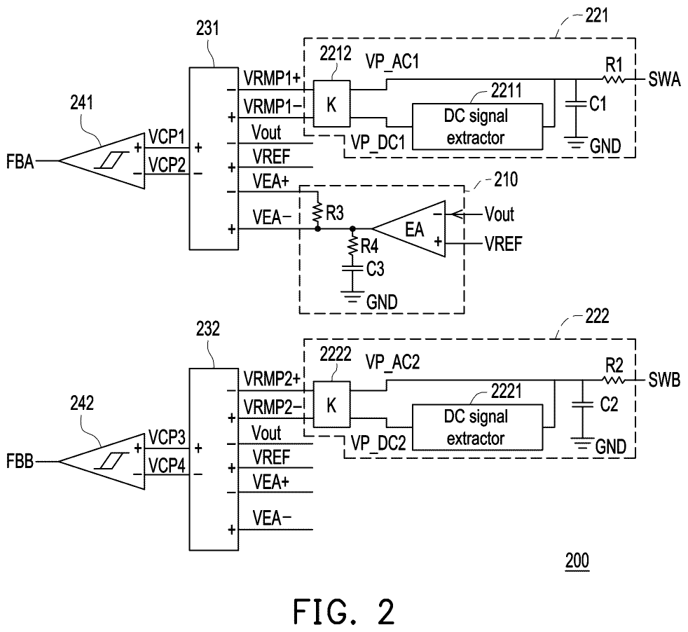

Please refer to FIG. 2. FIG. 2 is a schematic diagram of an implementation of a feedback circuit in a voltage conversion circuit according to an embodiment of the disclosure. A feedback circuit 200 may be used to implement the feedback circuit 120 of FIG. 1. The feedback circuit 200 includes an error voltage generator 210, signal processing circuits 221, 222, signal adders 231, 232, and comparators 241, 242. The error voltage generator 210 includes an error amplifier EA, resistors R3, R4, and a capacitor C3. A positive input terminal of the error amplifier EA receives the reference voltage VREF, and a negative input terminal of the error amplifier EA receives the output voltage Vout of the voltage conversion circuit. The resistor R3 and the capacitor C3 are coupled in series between the output terminal of the error amplifier EA and a reference grounding terminal GND, in which the output terminal of the error amplifier EA generates an error voltage VEA−. In addition, a terminal of the resistor R3 is coupled to the output terminal of the error amplifier EA, and the other terminal of the resistor R3 generates an error voltage VEA+. The error voltage VEA-is provided to a first positive input terminal of the signal adder 231 and a first positive input terminal of the signal adder 232, and the error voltage VEA+ is provided to a first negative input terminal of the signal adder 231 and a first negative input terminal of the signal adder 232.

The signal treatment circuit 221 includes a resistor R1, a capacitor C1, a DC signal extractor (RC extractor) 2211 and a signal amplifier 2212. A terminal of the resistor R1 receives the switching voltage SWA from the voltage converter 111, and the other terminal of the resistor R1 is coupled to the first terminal of the capacitor C1, the DC signal extractor 2211, and the signal amplifier 2212. The second terminal of the capacitor C1 is coupled to the reference grounding terminal GND. The DC signal extractor 2211 is coupled between the resistor R1 and the signal amplifier 2212. The DC signal extractor 2211 is used to extract a direct current component VP_DC1 of the switching voltage SWA. The signal amplifier 2212 receives an alternating current component VP_AC1 of the switching voltage SWA through the resistor R1, and receives the direct current component VP_DC1 of the switching voltage SWA output by the signal extractor 2211. The signal amplifier 2212 amplifies the direct current component VP_DC1 and the alternating current component VP_AC1 according to a gain K to generate a ramp voltage VRMP1+ and a ramp voltage VRMP1− respectively. The signal treatment circuit 221 outputs the ramp voltage VRMP1+ and the ramp voltage VRMP1− to the second negative input terminal and the second positive input terminal of the signal adder 231 respectively.

Similar to the signal treatment circuit 221, the signal treatment circuit 222 includes a resistor R2, a capacitor C2, a DC signal extractor 2221, and a signal amplifier 2222. A terminal of the resistor R2 receives the switching voltage SWB on the voltage converter 112, the other terminal of the resistor R2 is coupled to the first terminal of the capacitor C2, and the second terminal of the capacitor C2 is coupled to the reference grounding terminal GND. The DC signal extractor 2221 is used to extract a direct current component VP_DC2 of the switching voltage SWB. The signal amplifier 2212 receives an alternating current component VP_AC2 and the direct current component VP_DC2 of the switching voltage SWB. The signal amplifier 2222 amplifies the direct current component VP_DC2 and the alternating current component VP_AC2 according to the gain K to generate a ramp voltage VRMP2+ and a ramp voltage VRMP2− respectively. The signal treatment circuit 222 outputs the ramp voltage VRMP2+ and the ramp voltage VRMP2− to the second negative input terminal and the second positive input terminal of the signal adder 232 respectively.

The signal adders 231, 232 further include a third positive input terminal for receiving the reference voltage VREF and a third negative input terminal for receiving the output voltage Vout of the voltage conversion circuit. The signal adder 231 adds the signals received at the first, second, and third positive input terminals thereof, and generates a comparison voltage VCP1 at the positive output terminal thereof according to the addition result. The signal adder 231 further adds the signals received at the first, second, and third negative input terminals thereof, and generates a comparison voltage VCP2 at the negative output terminal according to the addition result. The signal adder 232 adds the signals received at the first, second, and third positive input terminals thereof, and generates a comparison voltage VCP3 at the positive output terminal thereof according to the addition result. The signal adder 232 further adds the signals received at the first, second, and third negative input terminals thereof, and generates a comparison voltage VCP4 at the negative output terminal thereof according to the addition result.

The comparator 241 receives the comparison voltages VCP1, VCP2 and generates the feedback signal FBA by comparing the comparison voltages VCP1, VCP2. The comparator 242 receives the comparison voltages VCP3, VCP4 and generates the feedback signal FBB by comparing the comparison voltages VCP3, VCP4. In this embodiment, the comparators 241, 242 may be hysteresis comparators.

In this embodiment, the circuit architectures of the DC signal extractors 2211, 2221, the signal amplifiers 2212, 2222, the signal adders 231, 232, and the comparators 241, 242 may be implemented by using related circuits known to persons skilled in the art without any specific limitation.

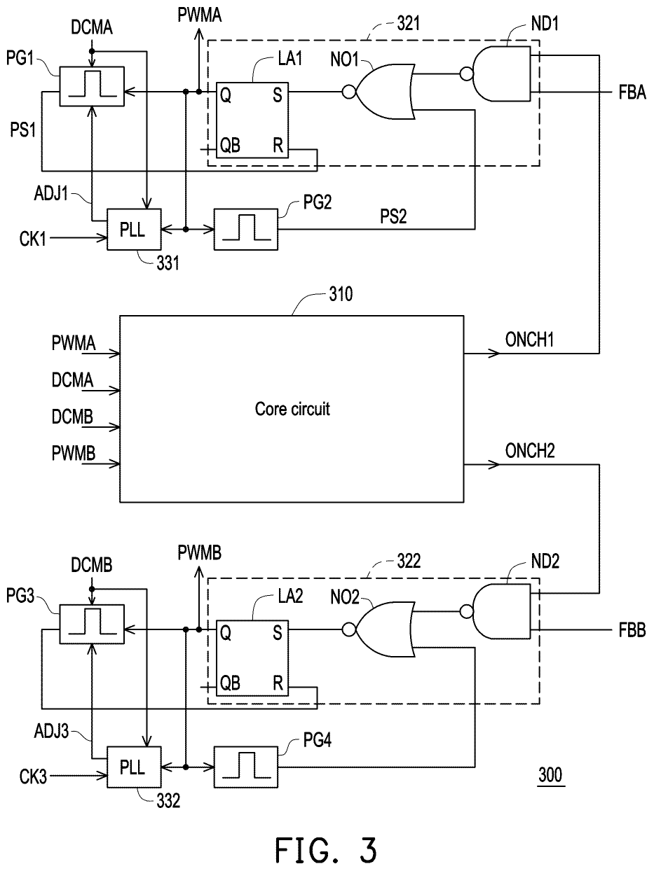

Please refer to FIG. 3. FIG. 3 is a schematic diagram of an implementation of an interleaving controller 300 in the voltage conversion circuit according to an embodiment of the disclosure. The interleaving controller 130 in the embodiment of FIG. 1 may be implemented using the interleaving controller 300. The interleaving controller 300 includes a core circuit 310, logic circuits 321, 322, phase-locked loops (PLL) 331, 332, and pulse generators PG1 to PG4. The core circuit 310 receives the control signals PWMA, PWMB and the pattern information DCMA, DCMB, a channel-on signal ONCH1 is generated according to the control signal PWMA and the pattern information DCMA, and a channel-on signal ONCH2 is generated according to the control signal PWMB and the pattern information DCMB. The channel-on signals ONCH1, ONCH2 are provided to the logic circuits 321, 322 respectively.

The logic circuits 321, 322 further receive the feedback signals FBA, FBB generated by the feedback circuit 200 respectively. The logic circuit 321 includes a NAND gate ND1, a NOR gate NO1, and a latch LA1. The NAND gate ND1 receives the channel-on signal ONCH1 and the feedback signal FBA, and the NOR gate NO1 receives the output signal of the NAND gate ND1 and the pulse wave PS2 generated by the pulse generator PG2. An output terminal of the NOR gate NO1 is coupled to a set terminal S of the latch LA1. In addition, a reset terminal R of the latch LA1 receives a pulse wave PS1 generated by the pulse generator PG1. An output terminal Q of the latch LA1 generates the control signal PWMA, and outputs the control signal PWMA to the pulse generators PG1, PG2 and the phase-locked loop 331.

In addition, the phase-locked loop 331 receives the pattern information DCMA, the control signal PWMA, and a clock signal CK1. The pattern information DCMA is used to control to turn on or turn off of the phase-locked loop 311. When the pattern information DCMA indicates that the voltage conversion circuit operates in the DCM mode, the phase-locked loop 331 may be turned off. In contrast, when the pattern information DCMA indicates that the voltage conversion circuit operates in the CCM mode, the phase-locked loop 331 may be turned on. The phase-locked loop 331 outputs an adjustment signal ADJ1 to the pulse generator PG1. The pulse generator PG1 may generate the pulse wave PS1 according to the pattern information DCMA, the control signal PWMA, and the adjustment signal ADJ1, and the pulse generator PG2 may generate a corresponding pulse wave PS2 according to the control signal PWMA.

In this embodiment, the pulse generator PG1 is a delay unit. When the control signal PWMA is at a logic value of 1, the pulse generator PG1 may start timing and pull down the pulse wave PS1. When the timing of the pulse generator PG1 is completed, the pulse wave PS1 is pulled high and the control signal PWMA is set to a logic value of 0. For the pulse generator PG2, when the control signal PWMA is at the logic value of 1, the pulse generator PG2 starts timing and increases the pulse wave PS2. When the timing of the pulse generator PG2 is completed, the pulse wave PS2 is reduced, thereby a minimum off-time control is formed. At the same time, the control signal PWMA may be sent to the phase-locked loop 331. The phase-locked loop 331 compares the phase difference between the control signal PWMA and the clock signal CK1 and adjusts the delay of PG1, and the stability of the voltage conversion frequency in the CCM mode is achieved.

The logic circuit 322 includes a NAND gate ND2, a NOR gate NO2, and a latch LA2. The NAND gate ND2 receives the channel-on signal ONCH2 and the feedback signal FBB, and the NOR gate NO2 receives the output signal generated by the NAND gate ND2 and the pulse wave PS4 generated by the pulse generator PG4. The output terminal of the NOR gate NO2 is coupled to the set terminal S of the latch LA2. In addition, the reset terminal R of the latch LA2 receives a pulse wave PS3 generated by the pulse generator PG3. An output terminal Q of the latch LA2 generates the control signal PWMB, and outputs the control signal PWMB to the pulse generators PG3, PG4 and the phase-locked loop 332. The phase-locked loop 332 receives the pattern information DCMB, the control signal PWMB, and a clock signal CK3, and outputs an adjustment signal ADJ3 to the pulse generator PG3. The pattern information DCMB is used to control to turn on or turn off the phase-locked loop 332. The operation manners of the logic circuit 322, the phase-locked loop 332, and the pulse generators PG3, PG4 are similar to the operation manners of the logic circuit 321, the phase-locked loop 331, and the pulse generators PG1, PG2, so details will not be repeated here. Through the phase-locked loops 331, 332, in the CCM mode, the control signal PWMA and the control signal PWMB respectively generated by the latches LA1, LA2 can be interleaved with each other.

It may also be noted that the latches LA1, LA2 are both SR type latches.

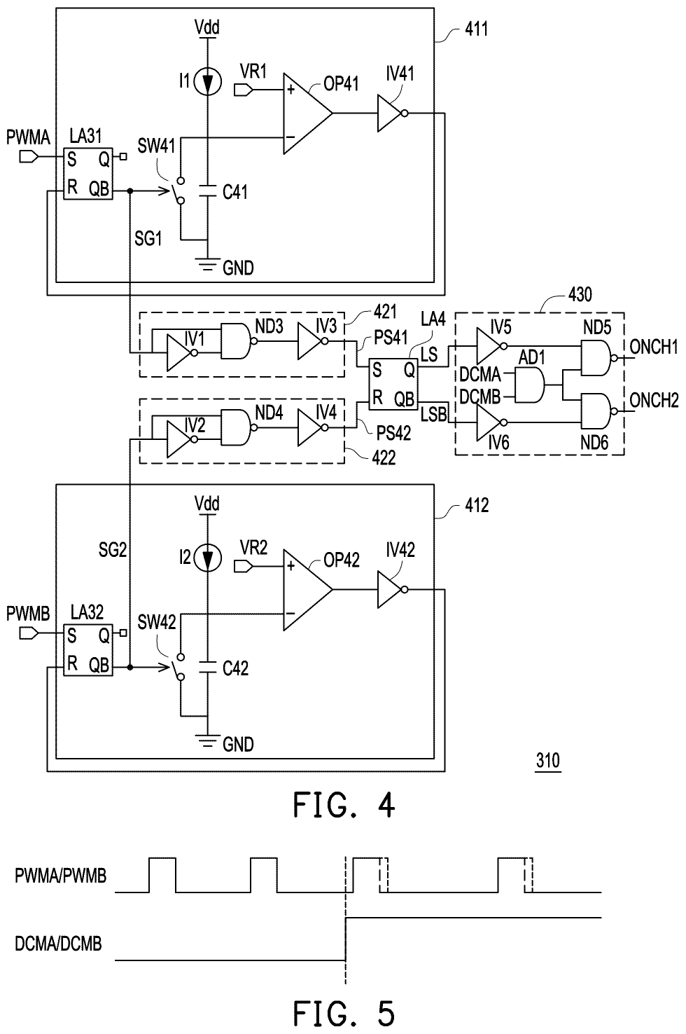

FIG. 4 is a schematic diagram showing an implementation of the core circuit in FIG. 3. In FIG. 4, the core circuit includes signal delayers 411, 412, single trigger circuits 421, 422, a latch LA4, and a logic circuit 430. The signal delayer 411 receives the control signal PWMA and is used to adjust the width of a signal SG1 according to a predetermined delay time. The predetermined delay time may be greater than half of a working period of the voltage conversion circuit. The signal delayer 411 includes a latch LA31, a switch SW41, a capacitor C41, a current source I1, an operational amplifier OP41, and an inverter IV41. The set terminal S of the latch LA31 receives the control signal PWMA, and the reset terminal R of the latch LA31 receives the signal output by the inverter IV41. An inverted output terminal QB of the latch LA31 generates the signal SG1. The switch SW41 is coupled in parallel with the capacitor C41. The switch SW41 and the capacitor C41 coupled in parallel are coupled in series with the current source Il between a power supply voltage Vdd and the reference grounding terminal GND. The node where the capacitor C41 and the current source Il are coupled is coupled to the negative input terminal of the operational amplifier OP41. The positive input terminal of the operational amplifier OP41 receives a reference voltage VR1. The output terminal of the operational amplifier OP41 is coupled to the input terminal of the inverter IV41.

The operational amplifier OP41 may generate an output voltage with a high voltage value in an initial state. During the period when the switch SW41 is turned off, the current source I1 may charge the capacitor C41. At this time, the negative input terminal of the operational amplifier OP41 receives a ramp voltage. When the ramp voltage rises to be greater than the reference voltage VR1, the output voltage generated by the operational amplifier OP41 may be converted to a low voltage value. During the period when the switch SW41 is turned on, the current source I1 does not charge the capacitor C41, and the capacitor C41 may be discharged through the switch SW41, and the ramp voltage on the negative input terminal of the operational amplifier OP41 is decreased rapidly. When the ramp voltage is decreased to less than the reference voltage VR1, the output voltage generated by the operational amplifier OP41 may be converted to a high voltage value.

By controlling the charging and discharging speed of the capacitor C41, the predetermined time delay mentioned above may be provided.

The signal delayer 412 includes a latch LA32, a switch SW42, a capacitor C42, a current source 12, an operational amplifier OP42, and an inverter IV42. The set terminal S of the latch LA32 receives the control signal PWMB, and the reset terminal R of the latch LA32 receives the signal output by the inverter IV42. The inverted output terminal QB of the latch LA32 generates a signal SG2. The switch SW42 is coupled in parallel with the capacitor C42. The switch SW42 and the capacitor C42 connected in parallel are coupled in series with the current source 12 between the power supply voltage Vdd and the reference grounding terminal GND. The node where the capacitor C42 and the current source 12 are coupled is coupled to the negative input terminal of the operational amplifier OP42. The positive input of the operational amplifier OP42 receives a reference voltage VR2. The output terminal of the operational amplifier OP42 is coupled to the input terminal of the inverter IV42.

The operation manner of the signal delayer 412 is similar to the signal delayer 411, so details will not be repeated here.

The single trigger circuit 421 receives the signal SG1 and generates a pulse wave PS41 according to the edge transition of the signal SG1. The single trigger circuit 422 receives the signal SG2 and generates a pulse wave PS42 according to the edge transition of the signal SG2. The set terminal S of the latch LA4 receives the pulse wave PS41, and the reset terminal R thereof receives the pulse wave PS42. The latch LA4 generates a latch signal LS at the output terminal Q thereof and generates an inverted latch signal LSB at the inverted output terminal QB thereof. The logic circuit 430 receives the latch signal LS, the inverted latch signal LSB, and the pattern information DCMA, DCMB, and perform logic operation on the latch signal LS, the inverted latch signal LSB, and the pattern information DCMA, DCMB to generate the channel-on signals ONCH1, ONCH2. Only when the pattern information DCMA, DCMB are both 1, the channel-on signal ONCH1 and the channel-on signal ONCH2 are controlled by the above logic, otherwise ONCH1, ONCH2 are set to 1, so as to achieve the interleave control mode switching without affecting the fast transient response when the load is transitioned.

The single trigger circuit 421 includes a NAND gate ND3 and inverters IV1, IV3. An input terminal of the NAND gate ND3 is coupled to the input terminal of the inverter IV1 to receive the signal SG1, and the other input terminal of the NAND gate ND3 is coupled to the output terminal of the inverter IV1. The output terminal of the NAND gate ND3 is coupled to the input terminal of the inverter IV3, and the output terminal of the inverter IV3 generates the pulse wave PS41. The single trigger circuit 422 includes a NAND gate ND4 and inverters IV2, IV4. An input terminal of the NAND gate ND4 is coupled to the input terminal of the inverter IV2 to receive the signal SG2, and the other input terminal of the NAND gate ND4 is coupled to the output terminal of the inverter IV2. The output terminal of the NAND gate ND4 is coupled to the input terminal of the inverter IV4, and the output terminal of the inverter IV4 generates the pulse wave PS42.

The logic circuit 430 includes inverters IV5, IV6, an AND gate AD1, and NAND gates ND5, ND6. The inverters IV5, IV6 receive the latch signal LS and the inverted latch signal LSB respectively. The AND gate AD1 receives the pattern information DCMA, DCMB. The NAND gate ND5 receives the output signal of the AND gate AD1 and the output signal of the inverter IV5, and generates the channel-on signal ONCH1. The NAND gate ND6 receives the output signal of the AND gate AD1 and the output signal of the inverter IV6, and generates the channel-on signal ONCH2.

In this embodiment, the latches LA31, LA32, LA4 are SR type latches. In addition, the circuit details of the single trigger circuits 421, 422 in FIG. 4 are merely examples for illustration and are not intended to limit the scope of implementation of the disclosure. Persons skilled in the art know that a single trigger circuit may be constructed in a variety of different ways, and the disclosure has no particular limitation. Similarly, the composition of the circuit components in the logic circuit 430 is not limited to be the same as in FIG. 4. The circuit details of the logic circuit 430 in FIG. 4 are also merely examples for illustration purposes.

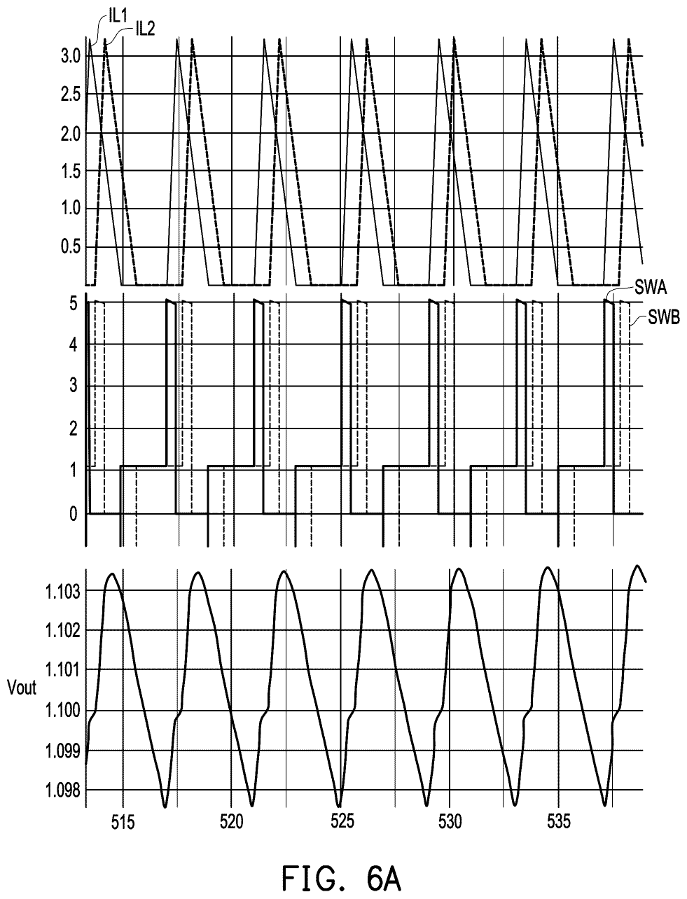

Please refer to FIG. 4 and FIG. 5 simultaneously in the description below. FIG. 5 is a signal waveform diagram of the core circuit of the embodiment of FIG. 4 of the disclosure. When the pattern information DCMA, DCMB are high logic values, the positive pulse widths of the control signals PWMA, PWMB may be correspondingly increased, thereby the hysteresis control of the voltage conversion circuit in the DCM mode is achieved.

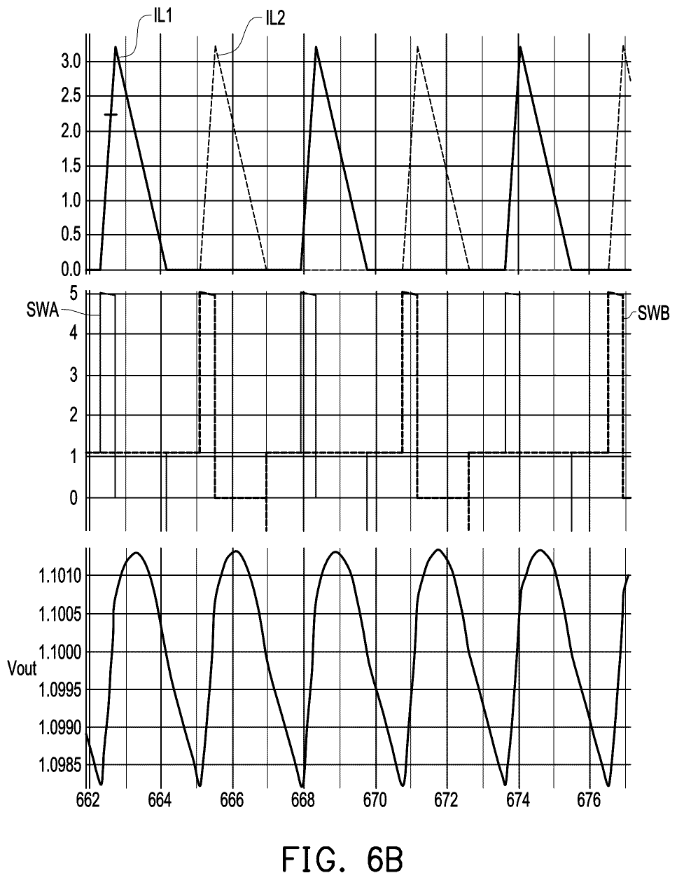

Please refer to FIG. 1, FIG. 6A, and FIG. 6B simultaneously in the description below. FIG. 6A and FIG. 6B are waveform diagrams of the switching voltage, the inductance current, and the output voltage of the voltage conversion circuit of the disclosure under different loads. In FIG. 6A, the voltage conversion circuit 100 operates under a load state of 1.5 amperes, for example, in which the currents IL1, IL2 passing through the inductors LA, LB respectively have a phase difference and present a quasi-interleave state. Likewise, the switching voltages SWA, SWB also present a quasi-interleave state. In this state, the ripple state of the output voltage Vout can be reduced by the quasi-interleave operation. In FIG. 6B, the voltage conversion circuit 100 operates under a load state of 0.8 amperes, for example, in which the currents IL1, IL2 passing through the inductors LA, LB respectively have a larger phase difference and present a full-interleave state. Likewise, the switching voltages SWA, SWB also present a full-interleave state. In this state, the ripple state of the output voltage Vout can be effectively reduced by the full-interleave operation.

In summary, the voltage conversion circuit can be effectively operated in a quasi-interleave or full-interleave state by controlling the voltage conversion circuit through the interleaving controller of the disclosure. In this way, the ripple of the output voltage can be effectively reduced, and the stability of the output voltage can be improved.

Finally, it should be noted that the above embodiments are only used to illustrate the technical solutions of the disclosure, rather than to limit the disclosure. Although the disclosure has been described in detail with reference to the embodiments, persons skilled in the art should understand that the technical solutions described in the embodiments may still be modified, or some or all of the technical features thereof may be substituted by equivalents. However, the 10 modifications or substitutions do not make the essence of the corresponding technical solutions deviate from the scope of the technical solutions of the embodiments of the disclosure.

What is claimed is:

1. A voltage conversion circuit, comprising:
a plurality of voltage converters, wherein the plurality of voltage converters are connected in parallel and jointly generate an output voltage according to a plurality of control signals respectively;
a feedback circuit, coupled to the plurality of voltage converters, generating a plurality of feedback signals according to a switching voltage on a power switch of each of the plurality of voltage converters and an error voltage between the output voltage and a first reference voltage; and
an interleaving controller, coupled between the feedback circuit and the plurality of voltage converters, wherein the interleaving controller comprises a plurality of phase-locked loops respectively corresponding to the plurality of voltage converters, the interleaving controller turns on or off a phase-locking mechanism according to a zero-crossing detection state of the power switch, and generates the plurality of control signals according to the plurality of feedback signals and the zero-crossing detection state respectively.

2. The voltage conversion circuit according to claim 1, wherein the plurality of voltage converters comprise:
a first voltage converter, receiving an input voltage; and
a second voltage converter, wherein an output terminal of the second voltage converter is coupled to an output terminal of the first voltage converter, and the second voltage converter receives the input voltage,
wherein the first voltage converter and the second voltage converter convert the input voltage according to a first control signal and a second control signal respectively to jointly generate the output voltage.

3. The voltage conversion circuit according to claim 2, further comprising:
a first current sensor, configured to sense a current on a first power switch of the first voltage converter to generate first current information, and to obtain a first zero-crossing detection state and first pattern information of the first power switch according to the first current information; and
a second current sensor, configured to sense a current on a second power switch of the second voltage converter to generate second current information, and to obtain a second zero-crossing detection state and second pattern information of the second power switch according to the second current information.

4. The voltage conversion circuit according to claim 3, wherein the feedback circuit comprises:
a first signal treatment circuit, extracting and amplifying a direct current component and an alternating current component of a first switching voltage of the first power switch of the first voltage converter, so as to generate a first ramp signal and a second ramp signal respectively;
a first adder, summing the first ramp signal, the first reference voltage, and a first error voltage to generate a first comparison voltage, and summing the second ramp signal, the output voltage, and a second error voltage to generate a second comparison voltage;
a first comparator, generating a first feedback signal by comparing the first comparison voltage and the second comparison voltage;
a second signal treatment circuit, extracting and amplifying a direct current component and an alternating current component of a second switching voltage of the second power switch of the second voltage converter, so as to generate a third ramp voltage and a fourth ramp voltage respectively;
a second signal adder, summing the third ramp signal, the first reference voltage, and the first error voltage to generate a third comparison voltage, and summing the fourth ramp signal, the output voltage, and the second error voltage to generate a fourth comparison voltage;
a second comparator, generating a second feedback signal by comparing the third comparison voltage and the fourth comparison voltage; and
an error voltage generator, configured to calculate an error between the output voltage and the first reference voltage to generate the first error voltage and the second error voltage.

5. The voltage conversion circuit according to claim 4, wherein the error voltage generator comprises:
an error amplifier, wherein a positive input terminal of the error amplifier receives the first reference voltage, a negative input terminal of the error amplifier receives the output voltage, and an output terminal of the error amplifier generates the first error voltage;
a first resistor and a first capacitor, coupled in series between the output terminal of the error amplifier and a reference grounding terminal; and
a second resistor, wherein a first terminal of the second resistor is coupled to the output terminal of the error amplifier, and a second terminal of the second resistor generates the second error voltage.

6. The voltage conversion circuit according to claim 1, wherein each of the first signal treatment circuit and the second signal treatment circuit comprises:
a first resistor, wherein a first terminal of the first resistor is configured to receive the first switching voltage or the second switching voltage;
a second capacitor, coupled between a second terminal of the first resistor and a reference grounding terminal;
a direct current signal extractor, coupled to the second terminal of the first resistor, configured to extract the direct current component of the first switching voltage or the second switching voltage; and
a signal amplifier, amplifying the direct current component and the alternating current component according to a gain to generate the first ramp voltage and the second ramp voltage respectively, or to generate the third ramp voltage and the fourth ramp voltage respectively.

7. The voltage conversion circuit according to claim 3, wherein the interleaving controller comprises:
a core circuit, generating a first channel-on signal according to the first control signal and the first pattern information, and generating a second channel-on signal according to the second control signal and the second pattern information;
a first phase-locked loop, receiving the first pattern information, the first control signal, and a first clock signal, and outputting a first adjustment signal to a first pulse generator;
the first pulse generator, providing a first pulse wave according to the first pattern information, the first control signal, and the first adjustment signal;
a second pulse generator, providing a second pulse wave according to the first control signal, wherein there is a first time delay between the first pulse wave and the second pulse wave;
a first logic circuit, generating the first control signal according to the first channel-on signal, a first feedback signal, the first pulse wave, and the second pulse wave;
a second phase-locked loop, receiving the second pattern information, the second control signal, and a second clock signal, and outputting a second adjustment signal to a third pulse generator;
the third pulse generator, providing a third pulse wave according to the second pattern information, the second control signal, and the second adjustment signal;
a fourth pulse generator, providing a fourth pulse wave according to the second control signal, wherein there is a second time delay between the third pulse wave and the fourth pulse wave; and
a second logic circuit, generating the second control signal according to the second channel-on signal, a second feedback signal, the third pulse wave, and the fourth pulse wave.

8. The voltage conversion circuit according to claim 7, wherein the first logic circuit enables the first control signal according to the first pulse wave and disables the first control signal according to the second pulse wave, and the second logic circuit enables the second control signal according to the third pulse wave and disables the second control signal according to the fourth pulse wave.

9. The voltage conversion circuit according to claim 7, wherein each of the first logic circuit and the second logic circuit comprises:
a NAND gate, receiving the first feedback signal and the first channel-on signal, or receiving the second feedback signal and the second channel-on signal;
a NOR gate, wherein a first input terminal of the NOR gate receives the first pulse wave or the third pulse wave, and a second input terminal of the NOR gate is coupled to an output terminal of the NAND gate; and
a latch, wherein a set terminal of the latch is coupled to an output terminal of the NOR gate, a reset terminal of the latch receives the second pulse wave or the fourth pulse wave, and an output terminal of the latch generates the first control signal or the second control signal.

10. The voltage conversion circuit according to claim 7, wherein the core circuit comprises:
a first signal delayer, receiving the first control signal, and adjusting a width of the first signal according to a predetermined delay time;
a second signal delayer, receiving the second control signal, and adjusting a width of the second signal according to the predetermined delay time;
a first single trigger circuit, receiving the first signal, and generating the first pulse wave according to an edge transition of the first signal;
a second single trigger circuit, receiving the second signal, and generating the second pulse wave according to an edge transition of the first signal;
a first latch, generating a latch signal and an inverted latch signal according to the first pulse wave and the second pulse wave; and
a third logic circuit, generating the first channel-on signal and the second channel-on signal according to the latch signal, the inverted latch signal, the first pattern information, and the second pattern information.

11. The voltage conversion circuit according to claim 10, wherein each of the first signal delayer and the second signal delayer comprises:
a second latch, having a set terminal for receiving the first control signal or the second control signal;
a switch, having a control terminal coupled to an inverted output terminal of the second latch;
a capacitor, coupled in parallel with the switch;
a current source, configured to provide a current to the capacitor or the switch;
an operational amplifier, having a negative input terminal coupled to the capacitor and a coupling terminal of the current source, wherein a positive input terminal of the operational amplifier receives a second reference voltage; and
an inverter, coupled between an output terminal of the operational amplifier and a reset terminal of a latch.

12. The voltage conversion circuit according to claim 10, wherein the predetermined delay time is greater than a half of a duty cycle of the voltage conversion circuit.
